(19) United States
(12) Patent Application Publication
(10) Pub. No.: US 2005/0178758 A1
(43) Pub. Date: Aug. 18, 2005

(54) Modular, angular direct steam cooker

(76) Inventors: Darrell C. Horn, Santa Rosa, CA (US); Janis Zakis, Glen Waverley (AU)

Correspondence Address: JOHNSON & STAINBROOK, LLP, 3558 ROUND BARN BLVD., SUITE 203, SANTA ROSA, CA, 95403, US

(21) Appl. No.: 10/781,366

(22) Filed: Feb. 17, 2004

(51) Int. Cl. A23L 1/10

(52) U.S. Cl. 219/401

(57) ABSTRACT

The modular, angular direct steam cooker of this invention provides an agitated continuous cooker apparatus which is heated with direct steam injection. The body of the cooker is designed in sections to allow increasing the capacity of the apparatus by adding sections of injectors to the length of the cooker. The food product is pumped into one end of the cooker and elevated to discharge out of the upper end of the cooker thus preventing air or steam vapor from forming pockets in the product as it progresses through the cooker from inlet to outlet. The slope of the cooking chamber can be increased or decreased to improve mixing and reduce compaction of different food products.

### CROSS REFERENCE TO RELATED APPLICATIONS

The present application claims the benefit of the filing date of U.S. Provisional Patent Application, Ser. No. 60/448,065, filed 15 Feb. 2003.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to cooking and food processing equipment, and more particularly to an improved agitated continuous cooker apparatus.

### BACKGROUND INFORMATION AND DISCUSSION OF RELATED ART

There are a variety of different continuous direct steam cooking systems in use today. Most of the continuous direct steam cooking systems are designed with an auger or screw to convey the food product through the cooker. This type of cooker does not mix the product at all, causing the direct steam to over cook some of the product near the steam injectors as the product is conveyed through the cooker. There are other cookers that use two agitators which intermesh to mix the product as it is conveyed. These cookers are effective on relatively viscous food products where the slow moving agitators fold the viscous product together while the stiff product itself assists in the mixing process. However, even with this type of mixing the direct steam is not effectively mixed into the product resulting in an uneven cook. There are over cooked and under cooked areas of product resulting in burned pieces of product.

One of the most effective direct steam cooking systems is a machine that has a vertical body with a rotating agitator that blends the steam, which is injected through ports along the side wall of the cooker body, into the product as it is pumped through the cooker. The body of this system is perfectly vertical with the food product entering at the bottom of the cooker body and exiting out of the top of the body. The agitator drive motor is positioned at the bottom of the cooker body below the product inlet and drives the agitator at varying RPM to mix the steam into the product to heat it to the set point temperature before it exits the cooker out of the top.

This type of cooker is very effective when cooking homogeneous products, however it is not as effective when cooking products that have particulates that tend to separate from the liquid ingredients of the product. When cooking homogeneous products such as process cheese the vertical body and vertical agitator works well because the ingredients that make up the product do not separate as they are pumped through the cooker chamber as the steam is injected along the side of the body to heat the cheese. The agitator can be operated a high RPM (between 800-3000 RPM) mixing the steam into the product for even heating.

However, if the product has particulates or other ingredients with different densities that tend to separate unless effectively blended, this type of cooker will not keep the particulates in perfect suspension for even cooking unless the agitators are operated at high RPMs. At high RPMs the agitator will damage the particulates. The vertical rotating shaft agitator is basically a very poor mixer when the agitator is operated at low RPM's since the spinning of the product about the agitator center shaft tends to separate heavy particulates from the lighter particulates due to the centrifugal force applied to the product as the agitator spins. This also occurs at high RPM, however, at high RPM the shape of the agitator will create forces counter to the centrifugal force which will mix the heavier particulates with the lighter particulates. The agitator with this counter centrifugal design and the forces that it causes damages fragile particulates even more than high RPM. The major advantage of the vertical shaft agitator is that is takes up very little factory space. Therefore, for cooking of homogenous products such as cheese, starch slurries, etc. this type of cooker is an excellent choice since high RPM is not a problem with these products.

There are many other applications where effective mixing at low RPM's is required, such as cooking products with particulated ingredients that have different densities from the base liquid. If the particulate ingredients are soft and fragile such as cooking diced beef or diced potato or diced vegetables, the product cannot be agitated vigorously or the particulates will be broken apart.

There are other food products that tend to pack in a vertically oriented continuous cooker. When cooking grain products with little or no liquid carrier the grains will tend to pack in the cooking chamber. Gravity creates a counter force to the pumping action pushing the product up through the cooker causing these types of products to pack and plug up inside of the cooker body. When cooking this type of product the force of gravity works against effective conveying of the product and therefore against effective continuous cooking of the product.

Existing continuous cookers are limited in capacity. Continuous cooking systems must be designed for a limited range of throughputs. Most products are sensitive to over mixing so the dwell time in the cooker must be minimized. For this reason the range of production rates that any given size cooker will cook effectively is quite limited. This is contrary to the normal growth a product line of food factory. If a food product has high quality and is marketed well, the sales of it will increase over the years. In order to deal with this growth a food factory must increase production. When they purchase continuous cooking equipment they typically must accurately project their needs and then in the beginning only run the equipment for a few days per week. As the product demand grows they add production days to the schedule. When they reach the full capacity of that piece of equipment they add more factory space and add another continuous cooker. This process of growth is very inefficient. The processor must purchase a larger machine than he needs in the beginning and occupy more factory space than he needs when he has low production requirements. When he reaches the capacity of one continuous system he must add expensive factory space and a second expensive machine system and go through the same inefficient growth pattern again.

The solution to this expensive growth process is to design equipment so that it is modular and can be expanded, however, existing continuous cookers are not modular and cannot be expanded to match production growth.

The foregoing discussion and references reflect the current state of the art of which the present inventor is aware. Reference to, and discussion of, these references is intended to aid in discharging Applicant's acknowledged duty of candor in disclosing information that may be relevant to the examination of claims to the present invention. However, it is respectfully submitted that none of the above-indicated references disclose, teach, suggest, show, or otherwise render obvious, either singly or when considered in combination, the invention described and claimed herein.

### BRIEF SUMMARY OF THE INVENTION

The present invention is a modular, angular direct steam cooker which provides an agitated continuous cooker apparatus which is heated with direct steam injection. The body of the cooker is designed in sections to allow increasing the capacity of the apparatus by adding sections of injectors to the length of the cooker. The food product is pumped into one (lower) end of the cooker and elevated to discharge out of the upper end of the cooker thus preventing air or steam vapor from forming pockets in the product as it progresses through the cooker from inlet to outlet. The slope of the cooking chamber can be selectively increased or decreased to improve mixing and reduce compaction of different food products.

It is therefore an object of the present invention to provide a new and improved continuous direct steam cooking apparatus.

It is another object of the present invention to provide a new and improved steam cooking apparatus for a variety of food products.

A further object or feature of the present invention is a new and improved cooking apparatus for food products that have particulates.

An even further object of the present invention is to provide a novel cooking apparatus that can be expanded in capacity.

Other novel features which are characteristic of the invention, as to organization and method of operation, together with further objects and advantages thereof will be better understood from the following description considered in connection with the accompanying drawing, in which preferred embodiments of the invention are illustrated by way of example. It is to be expressly understood, however, that the drawing is for illustration and description only and is not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawing wherein:

FIG. 1 is a schematic view of a prior art vertically oriented agitated continuous cooker apparatus;

FIG. 2 is a side elevation view of a modular, angular direct steam cooker apparatus of this invention, shown in a generally horizontal orientation;

FIG. 3 is a top plan view of the cooker apparatus of FIG. 2;

FIG. 4 is an end elevation view of the cooker apparatus of FIG. 2; and

FIG. 5 is a side elevation view of the cooker apparatus of FIG. 2 in a tilted orientation.

### DETAILED DESCRIPTION OF THE INVENTION

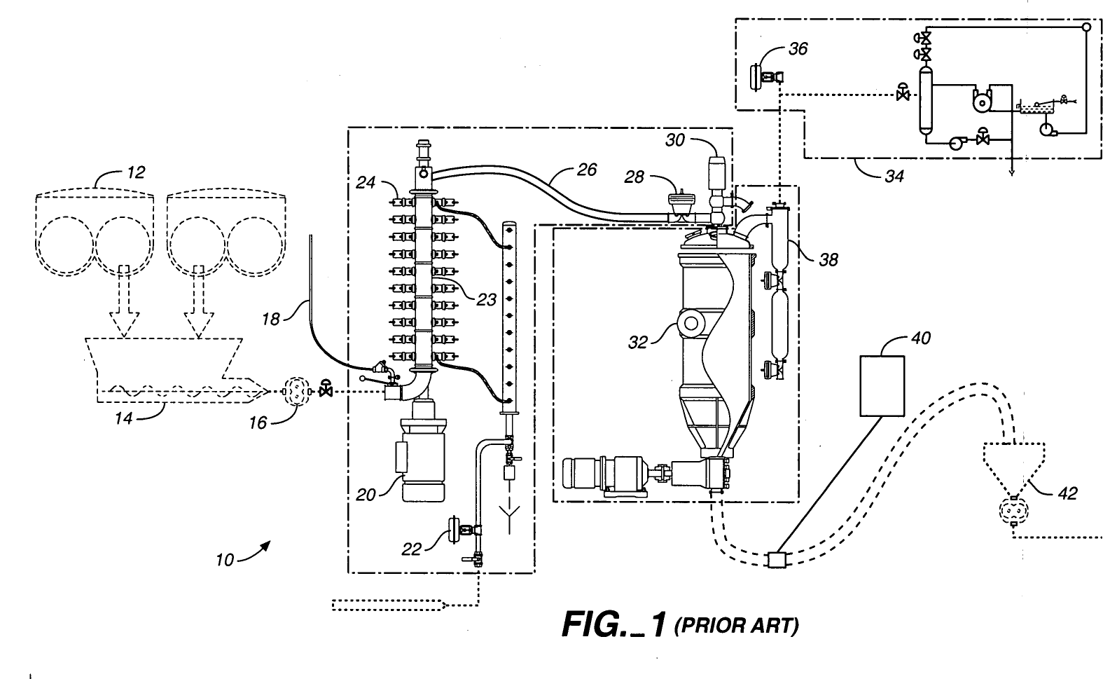

FIG. 1 is a schematic view of a prior art vertically oriented agitated continuous cooker apparatus 10. Vertical cooker 10 may be used in a system which includes a blender portion 12, screw auger 14, food pump 16, process water inlet 18, drive motor 20, steam valve 22, vertically oriented cooker body 23, injectors 24, holding tube 26, pressure control valve 28, diversion valve 30, vacuum flash vessel 32, vacuum generation system 34, vacuum control valve 36, liquid separator 38, moisture analyzer 40, and surge vessel 42, all as is well known in the art. As discussed supra, this type of direct steam cooking system is often effective when cooking homogeneous food products, but not as effective when cooking products that have particulates, or food products that tend to pack.

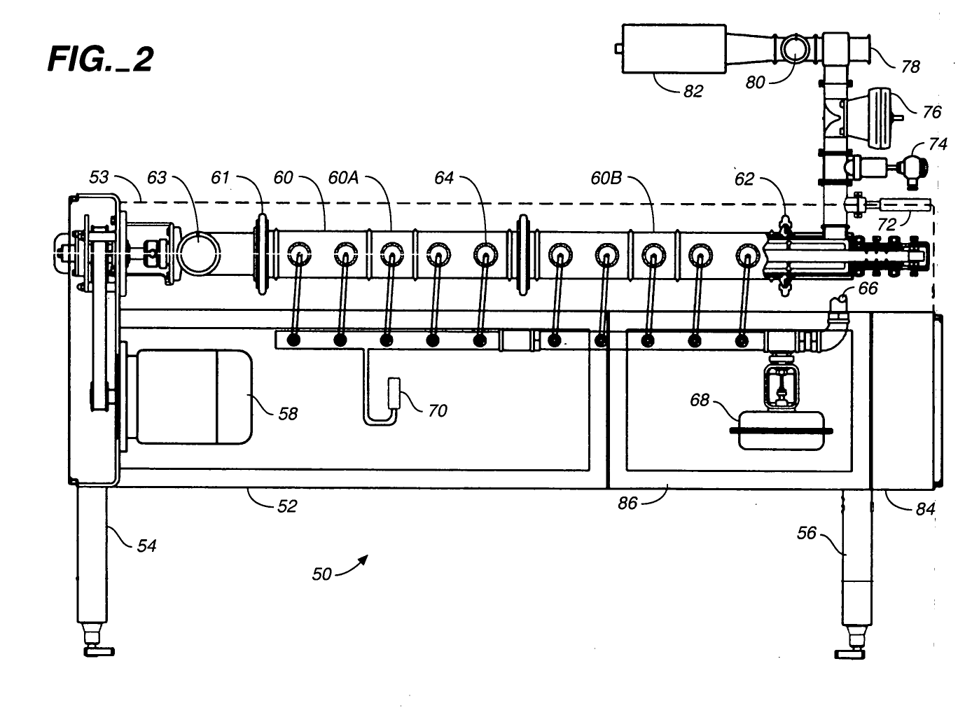

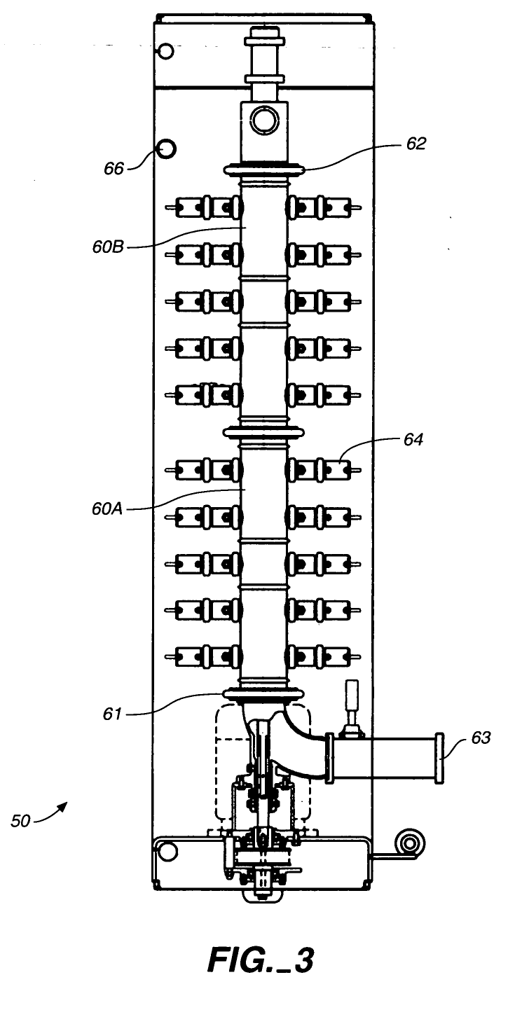

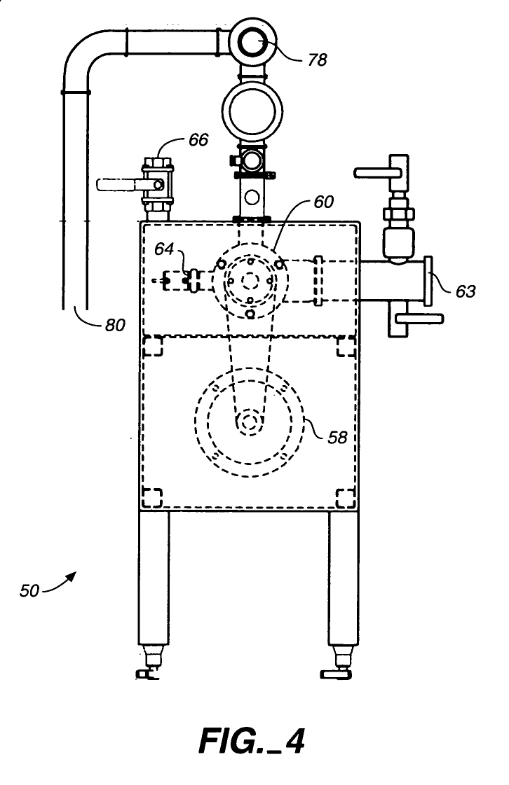

Referring now to FIGS. 2 through 5, wherein like reference numerals refer to like components in the various views, there is illustrated therein a new and improved modular, angular direct steam cooker apparatus, generally denominated 50 herein.

FIGS. 2-4 illustrate a first preferred embodiment of the modular, angular cooker 50 in a generally horizontal orientation. Angular cooker 50 may include a housing 52 having a hinged guard 54 and supported by inlet end legs or supports 54 and outlet end legs or supports 56, motor 58, cooker body 60 made up of cooker body modules 60A, 60B, and having an inlet end 61 and outlet end 62, product inlet 63, steam injectors 64, steam inlet 66, steam valve 68, steam pressure sensor 70, pressure sensor 72, self cleaning temperature sensor 74, cooking pressure control valve 76, product outlet 78, diverted product outlet 80, divert valve 82, and controls 84. The inclusion of additional modules such as module 60B to the cooker may involve additions to the housing in the form of extension frame 86.

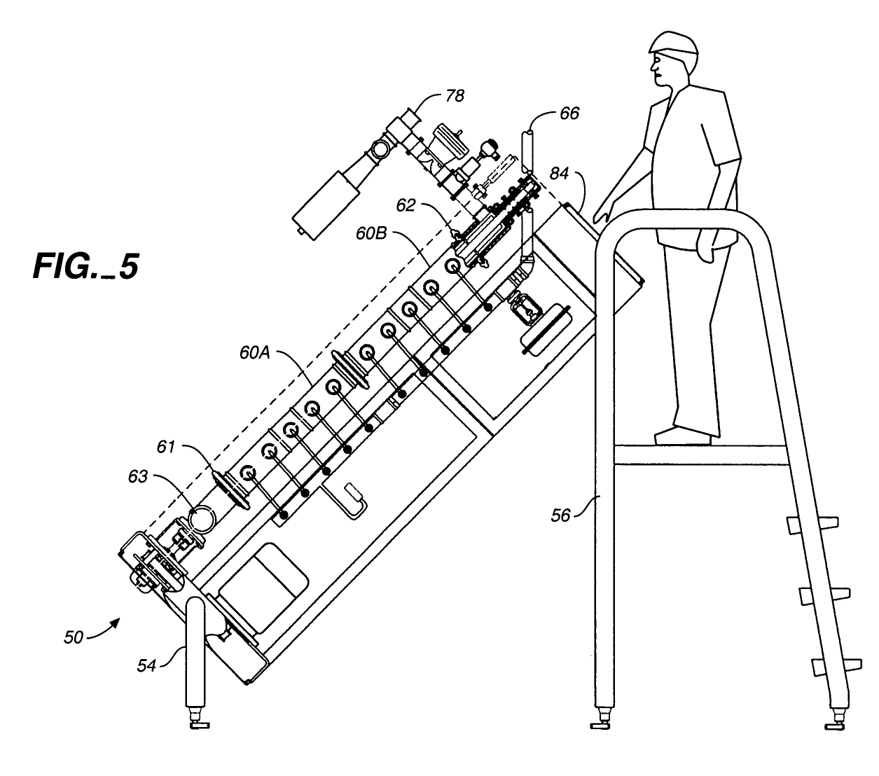

FIG. 5 is a side elevation view of the cooker apparatus 50 of FIGS. 2-4 in a tilted orientation. Tilting of the apparatus, and in particular the cooker body module(s) 60, can be achieved by the raising or extension of outlet end supports 56 by mechanical, hydraulic, or other means, or by any other method, in order to effect a desired angular orientation of the cooker body module(s) relative to the horizontal. This places the cooker body inlet end 61 below the outlet end 62.

This invention thus provides a continuous direct steam cooker which is designed to be positioned with the cooker body sloped at an angle of between 0 degrees and 90 degrees (e.g., 45 degrees) relative to the horizontal. The exact angle for operation is determined by the angle that is most effective for the particular food product which is being cooked. Any angle greater than 0 (e.g., 1 degree relative to horizontal) will have at least some of the beneficial effects described herein, while angles approaching 90 degrees (e.g., 89 degrees) will more closely approximate a vertical cooker.

For products with very fragile particulates the agitator must be rotated very slowly. With the agitator rotating at slow RPM (e.g., 100 RPM to 700 RPM) in order to protect the fragile particulates the cooker and agitator work much more effectively with body of the cooker and the agitator positioned at approximately 45 degrees with the horizontal (see FIG. 5). At an angle of 45 degrees relative to the horizontal the combination of gravity and centrifugal force at lower RPMs results in a more effective mixing of the food product without damage to the particulates.

Products with granular texture such as grain and grain products with little liquid to carry the grain particles through the machine have a tendency to pack and plug inside of the cooker. When operating in nearly the horizontal position this tendency to pack and plug is minimized. With this type of food product the cooker must be horizontal or almost horizontal to keep the product moving smoothly through the cooker as steam in injected into the product. The cooker shown in FIGS. 2-4 has a cooking column that is preferably nearly horizontal for cooking a grain product. The inlet of the cooker is at the lower end and the cooked product discharges vertically from the opposite end. The slight angle of the cooker allows air or steam vapor to escape to assure there are not pockets of air or vapor in the cooking column during the cooking process.

The invention is designed with bolted together modular sections to increase the length of the cooking chamber and add direct steam injectors as the requirements for increased capacity are required. The feed system, drive system, control system and back pressure system on the basic cooker are all capable of handling higher production. This means that to increase production as much as 100% the processor only has to add a cooker column section and new mixing rotor at a fraction of the cost of a new, larger cooker. The expanded cooker (with an additional cooking column section and longer mixing rotor) may have approximately twice the production capacity or more than the basic cooker with a single short cooking column.

Accordingly, the present invention may be characterized as an agitated direct steam continuous cooker apparatus comprising: a cooker body portion having an inlet end and an outlet end; and means for selectively elevating the outlet end relative to the inlet end at an angle of between 0 to 90 degrees, wherein food product may be pumped into the inlet end of the cooker body and discharged out of the outlet end of the cooker body, to improve mixing and reduce compaction of different food products.

Alternatively, the present invention may be characterized as a method for cooking food product in an agitated direct steam continuous cooker apparatus, the method comprising the steps of: providing a cooker body portion having an inlet end and an outlet end; elevating the outlet end relative to the inlet end at an angle of between 0 to 90 degrees; and pumping food product into the inlet end of the cooker body and discharging it out of the outlet end of the cooker body, to improve mixing and reduce compaction of different food products.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

1. An agitated direct steam continuous cooker apparatus comprising:
a cooker body portion having an inlet end and an outlet end; and
means for selectively elevating said outlet end relative to said inlet end at an angle of between 0 to 90 degrees, wherein food product may be pumped into said inlet end of said cooker body and discharged out of said outlet end of said cooker body, to improve mixing and reduce compaction of different food products.

2. The agitated continuous cooker apparatus of claim 1 wherein said cooker body portion is positioned at an angle of approximately 45 degrees relative to horizontal.

3. The agitated continuous cooker apparatus of claim 1 wherein said means for elevating comprises extensible supports.

4. The agitated continuous cooker apparatus of claim 1 wherein said cooker body portion is modular.

5. A method for cooking food product in an agitated direct steam continuous cooker apparatus, said method comprising the steps of: providing a cooker body portion having an inlet end and an outlet end;
elevating the outlet end relative to the inlet end at an angle of between 0 to 90 degrees; and
pumping food product into the inlet end of the cooker body and discharging it out of the outlet end of the cooker body, to improve mixing and reduce compaction of different food products.

6. The method of claim 5 wherein the cooker body outlet end is elevated so that the cooker body is positioned at an angle of approximately 45 degrees relative to horizontal.

7. The method of claim 5 wherein said step of elevating the outlet end comprises extending supports beneath one end of the cooker body.

8. The method of claim 5 wherein said step of elevating the outlet end comprises selectively tilting the cooker body to the angle that is most effective for the particular food product being cooked.
